(19) United States
(12) Patent Application Publication
(10) Pub. No.: US 2014/0017547 A1
(43) Pub. Date: Jan. 16, 2014

(54) ADDITIVE FOR ELECTROLYTES IN RECHARGEABLE LITHIUM ION BATTERIES

(71) Applicant: Guenter Eichinger, Altenstadt (DE)

(72) Inventor: Guenter Eichinger, Altenstadt (DE)

(73) Assignee: LI-TEC BATTERY GMBH, Kamenz (DE)

(21) Appl. No.: 13/813,295

(22) PCT Filed: May 6, 2011
(86) PCT No.: PCT/EP11/02418

§ 371 Date: Sep. 27, 2013

(30) Foreign Application Priority Data
May 19, 2010 (DE) 10 2010 020 992.9

(51) Int. Cl. H01M 10/0567; H01M 10/0525

(52) U.S. Cl. CPC H01M 10/0567; H01M 10/0525
USPC 429/144

(57) ABSTRACT

The invention relates to a method for reducing the loss of electrical capacitance of a rechargeable lithium ion battery when charging and discharging, comprising: (i) introducing an esterified aliphatic dicarboxylic acid into the electrolyte contained in the battery, said electrolyte comprising an organic solvent and a conducting salt.

The invention relates to a method for reducing the loss of electrical capacity of a rechargeable lithium ion battery during cyclic charging and discharging, wherein organic esters are added to the electrolyte of the battery. Further inventive subject matter relates to the electrolyte of the battery as well as the battery containing the electrolyte.

Secondary batteries, in particular lithium ion secondary batteries, are used for portable informational devices due to their high energy density and high capacity as energy stores. Such batteries are moreover also used for tools, electrically operated motor vehicles and vehicles with hybrid drives.

High demands are placed on such batteries in terms of their electrical capacity and energy density. They are to remain stable, particularly during the charge/discharge cycle, i.e. sustain the smallest possible loss of electrical capacity.

It is known that secondary batteries, for example rechargeable lithium ion cells, are subject to a loss of electrical capacity or an increase of internal resistance during charging/discharging cycles. One conceivable theory for this decrease places the blame on cover layers which can be formed from deposits from the electrolyte contained in the battery on the electrodes (SEI (solid electrolyte interface)). Such cover layers increase the internal resistance of the battery, whereby the capacity decreases.

DE 10 2006 025 471 A1 proposes counteracting such layer formation by adding silicon compounds to the electrolyte. Additionally introducing acyclic monocarboxylic acid ester compounds such as methyl formate, ethyl formate, ethyl acetate, propyl acetate, sec-butyl acetate, butyl acetate, methyl propionate and ethyl propionate is also proposed for stabilizing purposes.

DE 10 2006 055 770 A1 proposes increasing stability by means of an electrolyte containing lithium bis(oxalato)borate dissolved in a suitable solvent.

It is an object of the present invention to reduce the loss of capacity in a rechargeable lithium ion battery during cyclic charging and discharging without resorting to the above-cited compounds of the prior art.

This object is solved in that to lessen the loss of capacity in a rechargeable lithium ion battery when charging/discharging, one or more esterified aliphatic dicarboxylic acids is/are added to the electrolyte of the battery.

The subject-matter of the present invention is thus a method of reducing the loss of electrical capacity of a rechargeable lithium ion battery when charging/discharging comprising step (i):
(i) introducing an esterified aliphatic dicarboxylic acid into a non-aqueous electrolyte contained in the battery which comprises at least one organic solvent and one conducting salt.

Further subjects of the invention also include an electrolyte for a rechargeable lithium ion battery containing at least one esterified aliphatic dicarboxylic acid as well as a rechargeable lithium ion battery containing the inventive electrolyte.

The term “lithium ion battery” encompasses terms such as “lithium ion secondary battery,” “lithium battery,” “lithium ion accumulator” and “lithium ion cell.” This means that the term “lithium ion battery” is used as a collective term for the common afore-mentioned prior art terms.

Introducing the aliphatic dicarboxylic acid into the electrolyte in accordance with the invention reduces the loss of capacity occurring during the charging and discharging cycle.

The term “introducing” is synonymous with terms such as “adding,” “admixing” and “infusing.”

The loss of electrical capacity is particularly pronounced during the initial charge/discharge cycles since it is during these cycles that the cited cover layers are formed on the electrodes.

In one embodiment, the inventive method is characterized by reducing the loss of capacity after the initial charging and discharging and the second charging and discharging.

The battery's loss of capacity, which is irreversible, can be determined by determining the battery's capacity after the initial charge and after the initial discharge, respectively after the second charge and the second discharge. The expert is aware of appropriate methods for doing so.

In one embodiment of the method, the loss of capacity can be expressed as a capacity loss percentage (Q₁−Q₂)*100%/Q₁, wherein Q₁ is the capacity after the initial charge and discharge and Q₂ is the capacitance after the second charge. The corresponding loss of capacity can be determined analogously for each further cycle.

In one embodiment, the esterified dicarboxylic acid is selected such that when the esterified dicarboxylic acid is added to the electrolyte and the battery put into operation, the capacity loss is lower than the capacity loss of a battery having an electrolyte which does not contain esterified dicarboxylic acid and is put into operation.

The esterified dicarboxylic acid is preferably selected such that the irreversible capacity loss is at the most 90%, preferably 90%, particularly preferably 85% maximum, of the battery's irreversible capacity loss when operated without esterified dicarboxylic acid.

Even improvements in said capacity loss which seem nominally slight, for example 1-5%, are regarded as being significant improvements.

Since the loss in capacity is generally proportional to the increase in the battery's internal resistance, capacity loss can also be indirectly expressed by determining the increase in internal resistance. It is also possible to express capacity loss by means of the battery's applied voltage level or current draw during charging/discharging.

The phrase “method for reducing the loss of electrical capacitance” is synonymous with the phrases “method for reducing the increase of internal resistance,” “method for reducing the drop in voltage,” and “method for reducing the current loss.”

Hence, instead of determining the capacity loss, one embodiment can also determine the drop in the battery's voltage.

In one embodiment of the method, the capacity loss is expressed as a loss of voltage (U₁−U₂)*100%/U₁, wherein U₁ is the voltage after the initial charge and discharge and U₂ is the voltage after the second charge. The corresponding loss of voltage can be determined analogously for each further cycle.

In one embodiment of the method, the esterified aliphatic dicarboxylic acid is selected such that the voltage loss expressed as (U₁−U₂)*100%/U₁, wherein U₁ is the voltage after the initial charge and discharge and U₂ is the voltage after the second charge, is less than 10%.

In a further embodiment of the method, the esterified aliphatic dicarboxylic acid is selected such the voltage loss expressed as (U₁−U₂)*100%/U₁, wherein U₁ is the voltage after the initial charge and discharge and U₂ is the voltage after the second charge, is less than 5

In a further embodiment of the method, the esterified aliphatic dicarboxylic acid is selected such the voltage loss expressed as (U₁−U₂)*100%/U₁, wherein U₁ is the voltage after the initial charge and discharge and U₂ is the voltage after the second charge, is less than 1

The loss of electrical capacity can particularly be counteracted by the addition of esterified aliphatic dicarboxylic acid of the formula R₁—OOC—(CH2)ₓ-COO—R₂ to the electrolyte of a lithium ion battery, wherein x is an even number between 0 and 12, and R₁ and R₂ are unbranched or branched alkyl radicals independent of one another having 1 to 8 carbon atoms.

The esters used for the invention are either commercially available and/or can be produced using conventional methods which are known to the expert, for example by esterification of the dicarboxylic acids with applicable alcohols.

Symmetrical esters can be used; i.e. esters which exhibit the same alcohol components. In this embodiment, R₁ and R₂ are identical.

Using asymmetrical esters is likewise possible. Such esters exhibit different ester components; i.e. R₁ and R₂ are different.

Individual esters can be used as well as mixtures of two or more different esters.

In one embodiment, the esters are esters of dicarboxylic acids such as oxalic acid, malonic acid, succinic acid, glutaric acid, adipic acid, pimelic acid, azelaic acid, suberic acid or sebacic acid.

In one embodiment, ester of adipic acid are used as the dicarboxylic acid.

Adipic ester as known from the prior art can be used; i.e. dimethyl, diethyl, dipropyl, dibutyl, dipentyl or dihexyl adipate. While these compounds are used as plasticizers in the prior art, they are used in the present invention to reduce the loss in electrical capacity of a rechargeable lithium ion battery during charging/discharging.

DE 699 04 932 T2, for example, discloses a plasticizer for producing separators or electrodes used in electrochemical cells. Such plasticizers are used to form porous polymer structures. Dimethyl, diethyl, dipropyl, dibutyl, and dioctyl adipate are disclosed as suitable plasticizers. Dimethyl succinate, dimethyl suberate and dimethyl sebacate are also suitable. The plasticizers are removed prior to activating the electrochemical cell, for example by extraction.

DE 699 11 751 T2 discloses a rechargeable battery structure in the form of a laminate. The structure is formed using an adipic ester having an alcohol with up to six carbon atoms as an alcohol component. Formation of the structure makes use of dimethyl, diethyl, dipropyl, dibutyl, dipentyl or dihexyl adipate in the manufacturing process as a plasticizer. The document discloses that the dimethyl adipate (DMA) used in the examples is removed from the battery structure as well as can remain in the electrolyte of the battery at an amount of 5-20% by weight. As evidenced by examples I and II, there was greater initial loss in the battery structure containing DMA after the first cycle than the structure without DMA. Thus, overall, DE '751 teaches removing the plasticizer (ester) prior to activating the cell.

One embodiment of the present invention uses adipic acid in which the alcohol component contains an unbranched alkyl radical having 1 to 6 carbon atoms. In this embodiment, x=4 and R₁ and R₂ are identical and are methyl, ethyl, propyl, butyl, pentyl or hexyl.

In a further embodiment, x=4 and R₁ and R₂ are identical and are ethyl, propyl, butyl, pentyl or hexyl.

A further embodiment uses adipic acid in which the alcohol component contains a branched alkyl radical having 3 to 6 carbon atoms.

A further embodiment is characterized in that x=4 and R₁ and R₂ are an unbranched or branched alkyl radical having 2 to 6 carbon atoms.

Diethyl adipate and/or dibutyl adipate are also particularly effective adipic acid esters.

In this embodiment, the method according to the invention is characterized in that the esterified aliphatic dicarboxylic acid is diethyl adipate and/or dibutyl adipate.

In a further embodiment, x=0 and the esterified aliphatic dicarboxylic acid is selected from dimethyl oxalate, diethyl oxalate, dipropyl oxalate, dibutyl oxalate, dipentyl oxalate or dihexyl oxalate.

In a further embodiment, x=1 and the esterified aliphatic dicarboxylic acid is selected from dimethyl malonate, diethyl malonate, dipropyl malonate, dibutyl malonate, dipentyl malonate or dihexyl malonate.

In a further embodiment, x=2 and the esterified aliphatic dicarboxylic acid is selected from dimethyl succinate, diethyl succinate, dipropyl succinate, dibutyl succinate, dipentyl succinate or dihexyl succinate.

In a further embodiment, x=3 and the esterified aliphatic dicarboxylic acid is selected from dimethyl glutarate, diethyl glutarate, dipropyl glutarate, dibutyl glutarate, dipentyl glutarate or dihexyl glutarate.

In a further embodiment, x=5 and the esterified aliphatic dicarboxylic acid is selected from dimethyl pimelate, diethyl pimelate, dipropyl pimelate, dibutyl pimelate, dipentyl pimelate or dihexyl pimelate.

In a further embodiment, x=6 and the esterified aliphatic dicarboxylic acid is selected from dimethyl suberate, diethyl suberate, dipropyl suberate, dibutyl suberate, dipentyl suberate or dihexyl suberate.

In a further embodiment, x=7 and the esterified aliphatic dicarboxylic acid is selected from dimethyl azelate, diethyl azelate, dipropyl azelate, dibutyl azelate, dipentyl azelate or dihexyl azelate.

In a further embodiment, x=8 and the esterified aliphatic dicarboxylic acid is selected from dimethyl sebacate, diethyl sebacate, dipropyl sebacate, dibutyl sebacate, dipentyl sebacate or dihexyl sebacate.

A relatively large amount of esterified aliphatic dicarboxylic acid can be introduced into the electrolyte. It is generally effective when introduced at amounts of just up to 20% by weight relative the total weight of organic solvent and the esterified aliphatic dicarboxylic acid.

In one embodiment, the esterified aliphatic dicarboxylic acid is introduced into the electrolyte at a volume of 0.1-20% by weight relative the total weight of organic solvent and the esterified aliphatic dicarboxylic acid.

The esterified aliphatic dicarboxylic acid is preferably introduced at a volume of 0.5-5% by weight, 1-4% by weight is even more preferred.

The esterified aliphatic dicarboxylic acid can be introduced by adding it into the electrolyte via infusion.

It has been found that very good effectiveness can be achieved with only relatively low amounts; i.e. amounts less than 5% by weight or even less than 4% by weight.

In a further embodiment, the esterified aliphatic dicarboxylic acid is introduced into the electrolyte at a volume of 0.5-5% by weight relative the total weight of organic solvent and the esterified aliphatic dicarboxylic acid.

In a further embodiment, the esterified aliphatic dicarboxylic acid is introduced into the electrolyte at a volume of 1-4% by weight relative the total weight of organic solvent and the esterified aliphatic dicarboxylic acid.

It has been found that diethyl adipate and dibutyl adipate are potent compounds able to bring down the capacity loss to a highly advantageous degree. Such a compound has already proven very effective at concentration levels between 1-4% by weight.

The electrolyte used in the lithium ion battery is non-aqueous. It comprises at least one organic solvent and a conducting salt. The electrolyte for lithium ion batteries preferably comprises an organic solvent and a conducting salt dissolved therein, preferably lithium-based.

Preferred lithium salts comprise inert anions and are non-toxic. Suitable lithium salts are preferably lithium hexafluorophosphate, lithium hexafluoroarsenate, lithium bis(trifluoromethyl-sulfonyl)imide, lithium trifluoromethanesulfonate, lithium tris(trifluoromethylsulfonyl)methide, lithium tetrafluoroborate, lithium perchlorate, lithium tetrachloraluminate, lithium chloride, lithium(bisoxalato) borate or mixtures thereof.

In one embodiment, the lithium salt is selected from LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₊₁)₂ or LiC(SO₂CₓF₂ₓ₊₁)₃ with 0≦x≦8, Li[(C₂O₄)₂B] or mixtures of two or more of these salts.

The electrolyte is preferably provided as an electrolyte solution. Suitable solvents are preferably inert. Suitable solvents include for example ethylene carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, cyclopentanone, sulfolane, dimethyl sulfoxide, 3-methyl-1,3-oxazolidine-2-one, γ-butyrolactone, 1,2-diethoxy-methane, tetrahydrofuran, 2-methyltetrahydrofuran, 1,3-dioxolane, methyl acetate, ethyl acetate, nitromethane, 1,3-propanesultone or mixtures of two or more of these solvents.

In one embodiment, the conducting salt is LiPF₆.

In a further embodiment, the organic solvent is selected from ethylene carbonate, propylene carbonate, butylene carbonate, dimethyl carbonate, diethyl carbonate, ethyl methyl carbonate, methyl propy carbonate, butyl methyl carbonate, ethyl propyl carbonate, dipropyl carbonate or a mixture or two or more of same.

The electrolyte can comprise further additives as normally used in electrolytes for lithium ion batteries. These include for example radical scavengers such as biphenyl, flame-retardant additives such as organic phosphoric esters or hexamethylphosphoramide or acid scavengers such as amines. Electrolytes can also contain so-called overcharge protection additives such as cyclohexylbenzene.

Additives which can affect the formation of the “solid electrolyte interface” layer (SEI) on the electrodes, preferably electrodes containing carbons, can likewise be used in electrolytes. Vinylene carbonate is one such preferable additive.

It is known from the prior art that due to vinylene carbonate's reactivity, gas can form when lithium ion batteries are stored at increased temperatures. It is also known that the addition of a stabilizing additive can prevent such gassing. Propanesultone (PS) is one such additive, for example. It is however also known that such sultones have or could have carcinogenic properties. It has now surprisingly been discovered that esterified aliphatic dicarboxylic acids in accordance with the invention can be advantageously combined with vinylene carbonate such that the addition of propanesultone can be eliminated.

Accordingly, also advantageous is an embodiment in which the electrolyte contains at least one of the esterified aliphatic dicarboxylic acids and vinylene carbonate.

A further embodiment is also characterized in that the electrolyte contains at least one of the esterified aliphatic dicarboxylic acids and vinylene carbonate but no propanesultone.

A further object of the invention is a non-aqueous electrolyte for a rechargeable lithium ion battery characterized in that the electrolyte comprises:
at least one organic solvent;
at least one conducting salt;
at least one esterified aliphatic dicarboxylic acid, preferably an esterified aliphatic dicarboxylic acid of the formula R₁—OOC—(CH2)ₓ-COO—R₂, wherein x is an even number between 0 and 12, and R₁ and R₂ are unbranched or branched alkyl radicals independent of one another having 1 to 8 carbon atoms;
wherein the esterified aliphatic dicarboxylic acid is contained in the electrolyte at an amount of 0.5-4% by weight, preferably 1-2.5% by weight, relative the total weight of the organic solvent and the esterified aliphatic dicarboxylic acid.

The electrolyte thereby has the cited composition in particular during charging and/or discharging of the lithium ion battery.

A further subject of the invention is also an electrolyte for a rechargeable lithium ion battery, characterized in that said electrolyte comprises:
at least one organic solvent;
at least one conducting salt;
at least one esterified aliphatic dicarboxylic acid, preferably an esterified aliphatic dicarboxylic acid of the formula R₁—OOC—(CH2)ₓ-COO—R₂, wherein x is an even number between 0 and 12, and R₁ and R₂ are unbranched or branched alkyl radicals independent of one another having 1 to 8 carbon atoms;
wherein dimethyl adipate is excluded.

In one embodiment of the electrolyte, diethyl adipate, dipropyl adipate, dibutyl adipate, dipentyl adipate, dihexyl adipate are also excluded as an added esterified dicarboxylic acid additionally to dimethyl adipate.

In one embodiment, the non-aqueous electrolyte for a rechargeable lithium ion battery according to the invention is characterized in that said electrolyte comprises:
at least one organic solvent; at least one conducting salt;
at least one esterified aliphatic dicarboxylic acid of the formula R₁—OOC—(CH2)ₓ-COO—R₂, whereby x=4 and R₁ and R₂ are identical and are ethyl or butyl.

A further subject of the invention is also a lithium ion battery comprising a positive electrode, a negative electrode, a separator and the electrolyte in accordance with the invention.

The present invention also relates to using one of the preceding methods or electrolytes to reduce said loss of capacitance.

The term “positive electrode” refers to the electrode able to collect electrons when the battery is connected to a consumer, for example an electric motor. The positive electrode is then the cathode. The term “negative electrode” refers to the electrode able to release electrons during operation. The negative electrode is then the anode.

The anode of the inventive battery can be manufactured from a plurality of materials suitable for use in a battery with lithium ion electrolytes. The negative electrode can for example contain lithium metal or lithium in form of an alloy, either in the form of a foil, a mesh or in the form of particles bound together by an appropriate binder. The use of lithium metal oxides such as lithium titanium oxide is likewise possible. In principle, any material can be used which is able to form intercalation compounds with lithium. Suitable materials for the negative electrode then include for example graphite, synthetic graphite, carbon black, mesocarbon, doped carbon, fullerenes, niobium pentoxide, tin alloys, stannic oxide, silicon, titanium dioxide, and mixtures of these substances.

The cathode of the inventive battery preferably comprises a compound of the LiMPO₄ formula, whereby M is at least one transition metal cation of the first row of the periodic table of elements, wherein said transition metal cation is preferably selected from the group comprised of Mn, Fe, Ni and Ti or a combination of these elements, and wherein the compound preferably exhibits an olivine structure, preferably superordinate olivine, wherein Fe is particularly preferred.

A lithium iron phosphate having an olivine structure of the LiFePO₄ molecular formula can be used for the lithium ion battery according to the invention. It is however also possible to use a lithium iron phosphate containing the element M selected from the group consisting of Mn, Cr, Co, Cu, Ni, V, Mo, Ti, Zn, Al, Ga, B and Nb. It is furthermore also possible for the lithium iron phosphate to contain carbon so as to increase conductivity.

In a further embodiment, the olivene-structured lithium iron phosphate used to produce the positive electrode exhibits the molecular formula of LiₓFe_{1-y}M_{y}PO₄, wherein M represents at least one element selected from the group consisting of Mn, Cr, Co, Cu, Ni, V, Mo, Ti, Zn, Al, Ga, B and Nb at 0.05≦x≦1.2 and 0≦y≦0.8.

In one embodiment, x=1 and y=0.

The positive electrode preferably contains the lithium iron phosphate in the form of nanoparticles. The nanoparticles can be of any given form; i.e. they can be more or less spherical or elongated.

In one embodiment, the lithium iron phosphate exhibits a D₉₅ particle size measured at less than 15 μm. The particle size is preferably less than 10 μm.

In a further embodiment, the lithium iron phosphate exhibits a D₉₅ particle size measured at between 0.005 μm and 10 μm.

In a further embodiment, the lithium iron phosphate exhibits a D₉₅ particle size measured at less than 10 μm, whereby the D₅₀ value amounts to 4 μm ±2 μm and the D₁₀ value is less than 1.5 μm.

The values indicated can be determined by measuring with static laser scattering (laser diffraction, laser diffractometry). Such methods are known from the prior art.

In accordance with a preferred embodiment, the cathode can also comprise a lithium manganate, preferably spinel-type LiMn₂O₄, a lithium cobaltate, preferably LiCoO₂, or a lithium nickelate, preferably LiNiO₂, or a mixture of two or three of these oxides, or a lithium mixed oxide containing nickel, manganese and cobalt (NMC).

In a preferred embodiment, the cathode comprises at least one active material of a lithium-nickel-manganese-cobalt mixed oxide (NMC) not of a spinel structure in a mixture with a lithium-manganese oxide (LMO) of a spinel structure.

It is preferable for the active material to comprise at least 30 mol %, preferably at least 50 mol % NMC as well as at the same time at least 10 mol %, preferably at least 30 mol % LMO, in each case relative to the total molar number for the active material of the cathodic electrode (i.e. not relative the cathodic electrode as a whole which, additionally to the active material, can also include conductivity additives, binders, stabilizers, etc.).

It is preferable when the NMC and LMO together constitute at least 60 mol % of the active material, further preferred at least 70 mol %, further preferred at least 80 mol %, further preferred at least 90 mol %, in each case relative to the total molar number for the active material of the cathodic electrode (i.e. not relative the cathodic electrode as a whole which can also include conductivity additives, binders, stabilizers, etc. additionally to the active material).

There are in principle no limitations with respect to the composition of the lithium-nickel-manganese-cobalt mixed oxide besides for the oxide needing to contain, apart from the lithium, at least 5 mol %, preferably at least 15 mol %, further preferred at least 30 mol %, in each case of nickel, manganese and cobalt, in each case relative to the total molar number for the transition metals in the lithium-nickel-manganese-cobalt mixed oxide. The lithium-nickel-manganese-cobalt mixed oxide can be doped with any other metals, particularly transition metals, as long as the above-cited minimum Ni, Mn and Co molar concentrations can be ensured.

The following lithium-nickel-manganese-cobalt mixed oxide stoichiometry is particularly preferred: Li[Co_{1/3}Mn_{1/3}Ni_{1/3}]O₂, wherein the percentage of Li, Co, Mn, Ni and O can each vary by +/− 5%.

The lithium iron phosphate and/or the lithium oxide(s) used in the positive electrode as well as the materials used in the negative electrode (a) are generally held together by means of a binder binding said materials to the electrode, e.g. a polymer binder. Preferable binders include polyvinylidene fluoride, polyethylene oxide, polyethylene, polypropylene, polytetrafluoroethylene, polyacrylate, ethylene (propylene diene monomer) copolymer (EPDM) and mixtures and copolymers thereof.

The separator used in the battery must be permeable to lithium ions in order to ensure the ionic transport of lithium ions between the positive and the negative electrode. On the other hand, the separator needs to be insulating to electrons.

Separators as known in the prior art can be used.

In one embodiment, microporous films or membranes can be employed. In one embodiment thereof, the films or membranes comprise polyolefins. Suitable polyolefins are preferably polyethylene, polypropylene or polyethylene and polypropylene laminates. A further embodiment makes use of separators comprising non-woven polymer fibers.

In one embodiment, the separator of the inventive battery comprises a fibrous web of non-woven polymer fibers, also known as “non-woven fabrics,” which are electrically non-conductive. The term “non-woven fabric” is used synonymously with terms like “warp-knit” or “felt.” The term “non-woven” is at times also called “unwoven.”

The non-woven fabric is preferably flexible and has a thickness of less than 30 μm. Methods for manufacturing such non-woven fabrics are known in the prior art.

The polymer fibers are preferably selected from the group of polymers consisting of polyacrylnitrile, polyolefin, polyester, polyimide, polyetherimide, polysulfone, polyamide and polyether.

Suitable polyolefins are e.g. polyethylene, polypropylene, polytetrafluoroethylene and polyvinylidene fluoride.

Polyethylene terephthalates preferably constitute preferred polyesters.

In one preferred embodiment, the separator comprises a non-woven fabric which is coated on one or both sides with an inorganic material. The term “coating” also denotes that the inorganic ion-conducting material can not only be on one or both sides of said non-woven fabric but also within said non-woven fabric. The material used for the coating is preferably at least one compound from the group of oxides, phosphates, sulfates, titanates, silicates or aluminosilicates of at least one of the elements of zirconium, aluminum or lithium.

The inorganic ion-conducting material is preferably ion-conducting, i.e. ion-conducting to the lithium ions, in a temperature range of from −40° C. to 200° C.

In a preferred embodiment, the ion-conducting material comprises or consists of zirconium oxide.

A separator which at least partially consists of a permeable substrate which does not or only poorly conducts electrons can moreover be used. Said substrate is coated at least on one side with an inorganic material. The at least partially permeable substrate is made from an inorganic material formed as a non-woven fabric. The inorganic material is in the form of polymer fibers, preferably polymer fibers of polyethylene terephthalate (PET). The fabric is coated with an inorganic ion-conducting material which preferably conducts ions in a temperature range of from −40° C. to 200° C. The inorganic ion-conducting material preferably comprises at least one compound from the group of oxides, phosphates, sulfates, titanates, silicates, aluminosilicates having at least one of the elements zirconium, aluminum or lithium; the element zirconium oxide is particularly preferred. The inorganic ion-conducting material preferably exhibits particles having a maximum diameter of less than 100 nm.

One example of such a separator is marketed under the trade name of “Separion®” by the Evonik AG company in Germany.

Methods for manufacturing such separators are known in the prior art, for example from EP 1 017 476 B1, WO 2004/021477 and WO 2004/021499.

Large pores and holes in separators as used in secondary batteries can, in principle, lead to internal short circuits. The battery can then self-discharge in a dangerous reaction very quickly. Such high electric currents can thereby occur that, in the worst case, a closed battery cell can even explode. For this reason, the separator can decisively contribute to the safety and/or the lack of safety of a lithium high performance or a lithium high energy battery.

Polymer separators generally prevent any electricity transmission through the electrolytes as of a specific temperature (the so-called “shut-down temperature” which is about 120° C.). This happens due to the fact that at this temperature, the pore structure of the separator breaks down and all the pores are closed. Because ions can no longer be transported, this disrupts the dangerous reaction which can lead to an explosion. If the cell continues to heat up due to external factors, however, the so-called “break-down temperature” will be exceeded at approximately 150 to 180° C. Separator melting occurs as of this temperature, whereby it contracts. This creates a direct contact between the two electrodes at many points within the battery cell and thus occasions a wide-scale internal short circuit. The result is an uncontrolled reaction which can culminate in the cell exploding or the pressure which develops needing to be relieved by means of a pressure relief valve (breaker plate), frequently accompanied by open flame or sparks.

With the separator used in the battery according to invention comprising a non-woven fabric and the inorganic coating, a shut-down can occur when the polymer structure of the substrate melts due to the high temperature and infiltrates into the pores of the inorganic material, thereby closing them. However, the separator does not experience a break-down since the inorganic particles ensure that the separator cannot melt completely. This thus guarantees that there are no operating conditions under which a wide-scale short-circuit can occur

By exhibiting a particularly well-suited combination of thickness and porosity, the type of non-woven fabric utilized allows the manufacturing of separators which can meet the requirements separators face in high performance batteries, particularly high performance lithium batteries. Simultaneously making use of oxide particles of precisely coordinated particle size to produce the porous (ceramic) coating yields a finished separator of particularly high porosity, whereby the pores are still small enough to prevent unwanted “lithium whiskers” from growing through the separator.

Due to the high porosity of the separator, however, it needs to be ensured that no or only the smallest possible dead space develops in the pores.

The separators which can be employed in the inventive battery also have the advantage that some of the anions of the conducting salt deposit on the inorganic surfaces of the separator material, which leads to improved dissociation and thus to better ion conductivity at high currents.

The separator which can be employed in the inventive battery, comprising a flexible non-woven fabric having a porous inorganic coating on and in said fabric, wherein the material of the fabric is selected from non-woven, non-electrically conductive polymer fibers, is also characterized in that the non-woven fabric has a thickness of less than 30 μm, a porosity greater than 50%, preferably 50-97%, and a pore radius distribution in which at least 50% of the pores exhibit a 75-150 μm pore radius.

Particularly preferred is for the separator to comprise a non-woven fabric having a thickness of 5-30 μm, preferably 10-20 μm. As indicated above, the most homogenous possible pore radius distribution is also particularly preferred. In conjunction with optimally coordinated oxide particles of specific size, an even more homogenous pore radius distribution in non-woven fabric results in optimized separator porosity.

The thickness of the substrate greatly influences the separator's properties as not only the flexibility but also the sheet resistance of the electrolyte-soaked separator depends on the thickness of the substrate. The low thickness achieves particularly low separator electrical resistance when used with electrolytes. The separator itself exhibits a very high electrical resistance since it needs to have its own insulating properties. Additionally, thinner separators allow higher compacting within a battery stack such that a larger amount of energy can be stored in the same volume.

The non-woven fabric preferably has a porosity of 60-90%, particularly preferred is 70-90%. Porosity is thereby defined as the volume of the fabric (100%) minus the volume of the fabric's fibers; i.e. the percentage of the fabric's volume not filled with material. Fabric volume can thereby be calculated from the dimensions of the fabric. Fabric volume is yielded by the measured weight of the respective fabric and the density of the polymer fibers. The high porosity of the substrate also enables a higher separator porosity, which is why the separator can achieve a higher electrolyte intake.

To be able to obtain a separator with insulating properties, the separator comprises preferably non-electrically conductive polymer fibers as defined above for the polymer fibers of the non-woven fabric, same being preferably selected from among polyacrylnitrile (PAN), polyester such as e.g. polyethylene terephthalate (PET) and/or polyolefin (PO) such as e.g. polypropylene (PP) or polyethylene (PE) or mixtures of such polyolefins.

The polymer fibers of the non-woven fabrics preferably have a diameter of from 0.1 to 10 μm, particularly preferred from 1 to 4 μm.

Particularly preferred flexible non-woven fabrics have a surface weight of less than 20 g/m², preferably 5 to 10 g/m².

The separator exhibits a porous, electrically insulating ceramic coating on and in the non-woven fabric. The porous inorganic coating on and in the non-woven fabric preferably exhibits oxide particles of the Li, Al, Si and/or Zr elements having a mean particle size of 0.5 to 7 μm, preferably 1 to 5 μm, and highly preferably 1.5 to 3 μm. It is particularly preferred for the separator to exhibit a porous inorganic coating on and in the non-woven fabric which has aluminum oxide particles exhibiting a mean particle size of 0.5 to 7 μm, preferably 1 to 5 μm, and highly preferably of 1.5 to 3 μm, same being bonded to an oxide of the Zr or Si element. In order to obtain the highest porosity possible, preferably more than 50% by weight, and particularly preferably more than 80% by weight, of all the particles are within the above-cited range of mean particle size. As already described above, the maximum particle size is preferably ⅓ to ⅕, and particularly preferably less than or equal to 1/10, of the thickness of the non-woven fabric employed.

The separator preferably exhibits a porosity of 30 to 80%, preferably 40 to 75%, and particularly preferably 45 to 70%. Porosity hereby refers to the accessible; i.e. open, pores. Porosity can hereby be determined by means of the known mercury porosimetry method or can be calculated from the volume and the density of the raw materials employed when it can be assumed that there are only open pores.

The separators used for the inventive battery are also characterized in that they exhibit a tensile strength of at least 1 N/cm, preferably at least 3 N/cm and particularly preferably 3 to 10 N/cm. The separators can preferably be bent without damage to each radius down to 100 mm, preferably down to 50 mm and particularly preferably down to 1 mm. The separator's high tensile strength and high bending flexibility yield the advantage that the separator can experience the changes in electrode geometry occurring during charging and discharging of a battery without being damaged. The bending flexibility additionally yields the advantage of being able to commercially produce standardized coil cells with this separator. In such cells, the electrode/separator layers of standardized size are coiled together in contact.

The combination of the negative electrode and the positive electrode with particularly the separator and the electrolyte containing the esterified dicarboxylic acid, preferably the esterified dicarboxylic acid of the R₁—OOC—(CH2)ₓ-COO—R₂, formula, where x is an even number between 0 and 12 and R₁ and R₂ are unbranched or branched alkyl radicals independent of one another having 1 to 8 carbon atoms, results in a lithium ion battery which additionally to the decrease in irreversible loss of capacity during charging/discharging, advantageously also exhibits a reduction in the increase of the alternating current internal resistance, a reduction in the increase of the direct current internal resistance following charging of the battery as well as a reduction in the increase of the irreversible capacity loss following charging of the battery.

The lithium ion battery in accordance with the invention can in principle be manufactured using known prior art methods.

For example, the active material used to manufacture the positive electrode, for example lithium iron phosphate, can be deposited as powder on the electrode and compressed into a thin film, if necessary using a binder. The other electrode can be laminated onto the first electrode, whereby the separator is first laminated onto the negative or the positive electrode in form of a foil. It is also possible to simultaneously treat the positive electrode, the separator and the negative electrode by means of mutual laminating. The electrode/separator laminate is then encased in a housing. Electrolyte can be filled in as in the prior art as initially described above.

This combination of improved properties is extremely advantageous to using the inventive lithium ion battery in the charge/discharge cycle as power for informational devices, tools, electrically operated motor vehicles and motor vehicles with hybrid drives.

### EXAMPLES

A lithium ion battery with Separion® as the separator contained a mixture of ethyl carbonate and propylene carbonate as the electrolyte in a 1:1 ratio and at 1.15 mol of LiPF₆. The electrolyte contained 1.5% vinylene carbonate by weight and 2% biphenyl by weight relative to the total weight of the electrolyte. The battery was subjected to high current pulses at an initial temperature of 75° C. and then discharged (charge: 150 A, 5 pulses (628 W); discharge: 225 A, 1 pulse (790 W); total test time: 1 h). Voltage U₁ was measured at the start of the test cycle and voltage U₂ was measured at the end of the first test cycle, whereby 2% by weight of the compounds indicated in the table were added to the electrolyte. The reference electrolyte did not contain any added ester. Propionic acid methyl ester as known from the prior art was furthermore included in the test for comparison:

| | First test cycle | | |
|---|---|---|---|
| | | | (U₁ − U₂)*100/U₁ |
| | U₁ [V] | U₂ [V] | [%] |
| Reference (no ester) | 3.33 | 2.84 | 14.7 |
| Propionic acid methyl ester | 3.49 | 3.2 | 8.3 |
| Diethyl adipate | 3.52 | 3.44 | 2.27 |
| Dibutyl adipate | 3.69 | 2.62 | 0.18 |
| Diethyl sebacate | 3.71 | 3.65 | 0.16 |

A second test cycle was thereafter run, wherein U₁ was the voltage at the start of the second test cycle and U₂ the voltage at the end of the second test cycle:

| | Second test cycle | | |
|---|---|---|---|
| | | | (U₁ − U₂)*100/U₁ |
| | U₁ [V] | U₂ [V] | [%] |
| Reference (no ester) | 3.43 | 2.50 | 27 |
| Propionic acid methyl ester | 3.28 | 2.92 | 11 |
| Diethyl adipate | 3.39 | 3.32 | 2.18 |
| Dibutyl adipate | 3.56 | 3.50 | 0.16 |
| Diethyl sebacate | 3.71 | 3.59 | 3.23 |

The results confirm the good cycle stability; i.e. the low loss of voltage compared to the reference sample and the reference ester despite the relatively high testing temperature.

1-16. (canceled)

17. A lithium ion battery comprising
a positive electrode,
a negative electrode,
a separator and
an electrolyte comprising
at least one organic solvent;
at least one conducting salt; and
at least one esterified aliphatic dicarboxylic acid of the formula R₁—OOC—(CH2)ₓ-COO—R₂, wherein x is an even number between 0 and 12 and R₁ and R₂ are unbranched or branched alkyl radicals independent of one another having 1 to 8 carbon atoms; and
a separator comprising a non-woven fabric of non-woven polymer fibers which is coated on one or both sides with an inorganic ion-conducting material.

18. The lithium ion battery according to claim 17, wherein the inorganic ion-conducting material is a compound from the group of oxides, phosphates, sulfates, titanates, silicates or aluminosilicates of at least one of the elements of zirconium, aluminum or lithium.

19. The lithium ion battery according to claim 17, wherein:
the polymer fibers are polymer fibers of polyethylene terephthalate;
the inorganic ion-conducting material is a compound from the group of oxides, phosphates, sulfates, titanates, silicates or aluminosilicates of at least one of the elements of zirconium, aluminum or lithium, preferably zirconium oxide; and
the inorganic ion-conducting material preferably exhibits particles having a maximum diameter of less than 100 nm.

20. The lithium ion battery according to claim 17, wherein R₁ and R₂ are identical.

21. The lithium ion battery according to claim 20, wherein x=4 and R₁ and R₂ are ethyl, propyl, butyl, pentyl or hexyl.

22. The lithium ion battery according to claim 17, wherein the esterified aliphatic dicarboxylic acid is diethyl adipate or dibutyl adipate.

23. The lithium ion battery according to claim 17, wherein:
x=5 and the esterified aliphatic dicarboxylic acid is selected from among dimethyl pimelate, diethyl pimelate, dipropyl pimelate, dibutyl pimelate, dipentyl pimelate or dihexyl pimelate; or
x=6 and the esterified aliphatic dicarboxylic acid is selected from among dimethyl suberate, diethyl suberate, dipropyl suberate, dibutyl suberate, dipentyl suberate or dihexyl suberate; or
x=7 and the esterified aliphatic dicarboxylic acid is selected from among dimethyl azelate, diethyl azelate, dipropyl azelate, dibutyl azelate, dipentyl azelate or dihexyl azelate; or
x=8 and the esterified aliphatic dicarboxylic acid is selected from among dimethyl sebacate, diethyl sebacate, dipropyl sebacate, dibutyl sebacate, dipentyl sebacate or dihexyl sebacate.

24. The lithium ion battery according to claim 17, wherein the esterified aliphatic dicarboxylic acid is introduced into the electrolyte at a volume of 0.1-20% by weight relative the total weight of the organic solvent and the esterified aliphatic dicarboxylic acid, or that the esterified aliphatic dicarboxylic acid is introduced into the electrolyte at a volume of 0.5-5% by weight, or that the esterified aliphatic dicarboxylic acid is introduced into the electrolyte at a volume of 1-4% by weight.

25. The lithium ion battery according to claim 17, characterized in that the conducting salt is selected from among lithium hexafluorophosphate, lithium hexafluoroarsenate, lithium bis(trifluoromethyl-sulfonyl)imide, lithium trifluoro-methanesulfonate, lithium tris(trifluoromethylsulfonyl)methide, lithium tetrafluoroborate, lithium perchlorate, lithium tetrachloroaluminate, lithium chloride, lithium(bisoxalato) borate or mixtures thereof.

26. The lithium ion battery according to claim 17, wherein the organic solvent is selected from among ethylene carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate or a mixture of two or more of same.

27. The lithium ion battery according to claim 17, wherein the electrolyte comprises:
at least one esterified aliphatic dicarboxylic acid of the formula R₁—OOC—(CH2)ₓ-COO—R₂, whereby x=4 and R₁ and R₂ are identical and are ethyl or butyl,
wherein the esterified aliphatic dicarboxylic acid is contained in the electrolyte at an amount of 0.5-4% by weight, preferably 1-2.5% by weight, relative the total weight of the organic solvent and the esterified aliphatic dicarboxylic acid.

28. The lithium ion battery according to claim 17, wherein the electrolyte comprises at least one of the esterified aliphatic dicarboxylic acids and vinylene carbonate.
